(19) United States
(12) Patent Application Publication
(10) Pub. No.: US 2024/0067076 A1
(43) Pub. Date: Feb. 29, 2024

(54) STRAP CONTAINER

(71) Applicant: MB Companies, LLC, Roseville, MN (US)

(72) Inventor: John Herbert MONTGOMERY, Roseville, MN (US)

(73) Assignee: MB Companies, LLC, Roseville, MN (US)

(21) Appl. No.: 18/453,656

(22) Filed: Aug. 22, 2023

Related U.S. Application Data
(60) Provisional application No. 63/400,272, filed on Aug. 23, 2022.

(51) Int. Cl. B60P 7/08

(52) U.S. Cl. CPC B60P 7/0846; B60P 7/0853

(57) ABSTRACT

A strap container that includes a housing and a winding assembly, such that the housing defines a compartment configured to store at least a portion of a strap. A sidewall of the housing has two or more protuberances extending outwardly, and one or more slots. The winding assembly is rotatably coupled to and extends through a base wall of the housing that is perpendicular to the sidewall. The winding assembly includes a strap coupling mechanism configured to removably secure the loose end of the strap within the compartment. A handle exterior to the housing includes a protrusion. The handle may switch between a deployed position that is operable to rotate the winding assembly and a stowed position to lock the handle, and to secure the strap within the housing. In the stowed position, the protrusion resides between two protuberances of the housing so as to prevent rotation of the winding assembly.

### PRIORITY CLAIM

The present application claims priority from U.S. Provisional Patent Application No. 63/400,272, filed Aug. 23, 2022, which is hereby fully incorporated herein by reference.

### TECHNICAL FIELD

Embodiments of the present disclosure relate generally to tie-down straps used to secure loads, and more particularly to a container for storage of excess strap during use.

### BACKGROUND

Tie down straps, such as ratchet straps or tow straps, are commonly used for securing various types of cargo, usually while vehicles are in transit. Tie down straps provide several advantages over alternate securement means, such as ropes or cables, because they provide improved pressure distribution on the load due to a greater area of contact, are less likely to tangle or knot, and can incorporate tightening mechanisms to simplify the tightening process.

Ratchet straps typically include a first fixed length of webbing that is fixedly attached to one end of a ratchet body and a second variable length of webbing that can be drawn out or retracted based on the size of cargo. In use or transit, loose ends of the variable length webbing may flap in the wind. These loose ends can be noisy and can cause damage to the vehicle, cargo, or straps themselves via accelerated fraying and wear and tear during transit on the highway, for example.

Conventional solutions to addressing the excess of the variable length of webbing include tying off, folding, or otherwise securing the strap ends. Such strap management techniques can require additional time during both tightening and loosening of the ratchet straps and often do not fully prevent the straps from becoming dirty, tangled, or loose during transport.

Further, conventional solutions that incorporate spools or coils to store ratchet straps face several problems. These storage solutions are generally bulky, incorporate loose pins or parts that can be lost or damaged during use or during transit of vehicles on which they are used, are not compatible with existing straps, and can make the straps become misaligned, unwound or frayed.

Accordingly, improved systems and methods are desired for storing existing ratchet straps in a portable and secure manner.

### SUMMARY

The techniques of this disclosure generally relate to a strap container configured to improve management of a loose end of a ratchet strap, so as to protect the ratchet strap from wear and tear without requiring a specially designed strap or any changes to be made to the strap itself.

In one aspect, the present disclosure provides a strap container configured to removably store a ratcheting strap. The strap container includes a housing and a winding assembly. The housing defines a compartment configured to store an end of the ratcheting strap. The housing has a sidewall including two or more protuberances extending outward and one or more slots configured to allow passing of the ratcheting strap therethrough. The winding assembly is rotatably coupled to and extends through a base wall of the housing that is perpendicular to the sidewall. The winding assembly includes a strap coupling mechanism configured to removably couple the end of the ratcheting strap within the compartment, and a handle exterior to the housing. The handle includes a protrusion and is operable to switch between a deployed position and a stowed position. In the deployed position the winding assembly can be wound to retract the ratcheting strap or unwound to deploy the ratcheting strap, and in the stowed position the protrusion is configured to reside between the two or more outward protuberances of the housing so as to inhibit rotation of the winding assembly.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1A is a front perspective view of a strap container according to an embodiment.

FIG. 1B is a side perspective view of the strap container of FIG. 1A.

FIG. 1C is a front view of the strap container of FIG. 1A.

FIG. 1D is a back perspective view of the strap container of FIG. 1A.

FIG. 1E is a back view of the strap container of FIG. 1A.

FIG. 1F is a perspective sectional view of the strap container of FIG. 1A.

FIG. 1G is another perspective sectional view the strap container of FIG. 1A.

FIG. 2A is a perspective sectional view of a strap container according to an embodiment.

FIG. 2B is another perspective sectional view of the strap container of FIG. 2A.

FIG. 3 is a flowchart of a method for storing a strap in a strap container according to embodiments.

FIG. 4A is a perspective view of a strap container with a handle in a deployed position according to an embodiment.

FIG. 4B is another perspective view of the strap container of FIG. 4A.

FIG. 5A is a front perspective view of an alternative strap container according to an embodiment.

FIG. 5B is a side perspective view of the alternative strap container of FIG. 5A.

FIG. 5C is a front view of the alternative strap container of FIG. 5A.

FIG. 5D is a back perspective view of the alternative strap container of FIG. 5A.

FIG. 5E is a perspective internal view of the front cover of the alternative strap container of FIG. 5A.

FIG. 5F is a perspective sectional view of an alternative strap container of FIG. 5A.

FIG. 5G is a perspective internal view of the back cover of the alternative strap container of FIG. 5A.

FIG. 5H is a side view of the back cover of the alternative strap container of FIG. 5A.

FIG. 6 is a perspective view of an alternative strap container with a handle in a deployed position according to an embodiment.

FIG. 7 is a perspective view of an alternative strap container with a handle in a neutral position according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments of the present disclosure are directed to devices, systems, and methods for the secure storage of loose ends of tie down straps. In particular, a strap container of the present disclosure can provide a housing and winding assembly for retraction and deployment of a ratchet strap. The housing is configured to protect the loose end of the tie down strap while maintaining a minimal profile. The minimal profile of the housing enables the container to be easily transported to any jobsite where a ratchet strap may be required. The winding assembly is a unitary structure (i.e., no loose parts are required). Additionally, the winding assembly provides locking functionality to prevent unwanted retracting or deployment of the ratchet strap.

The strap container, and components thereof, may be made of any suitable materials known in the art, including but not limited to thermoplastic, plastic, metal, or the like. For example, and without limitation, the housing, winding assembly, and external clip attached to an external surface of the housing may be composed of a durable thermoplastic material, while pins and other fasteners associated with the strap container may be composed of metal.

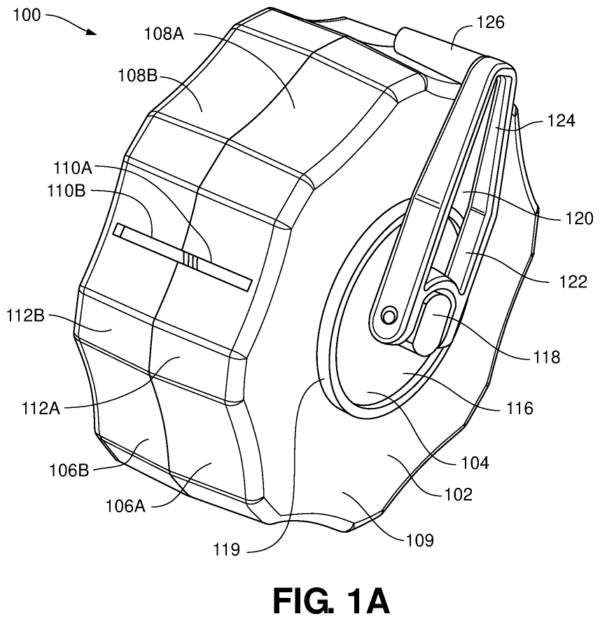

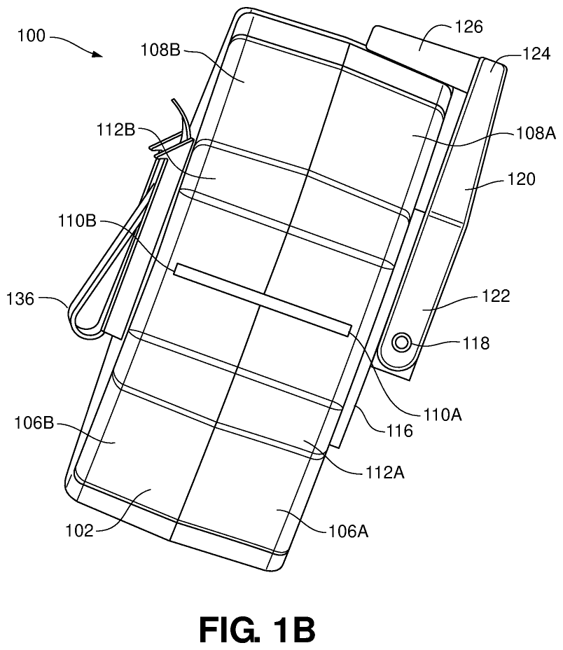

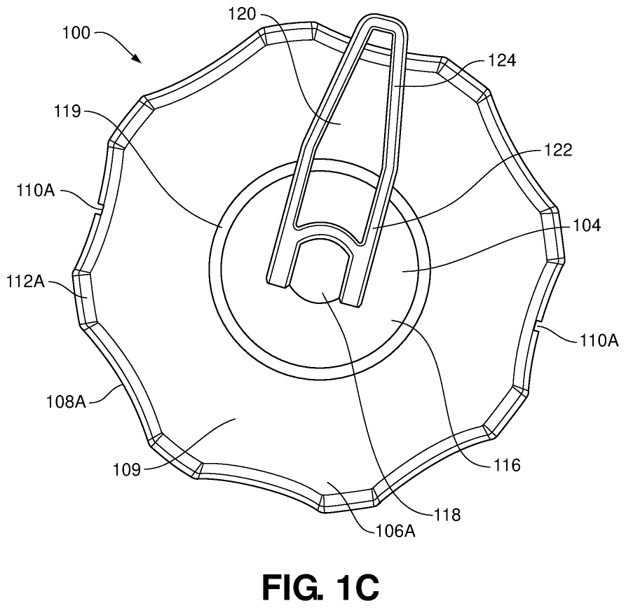

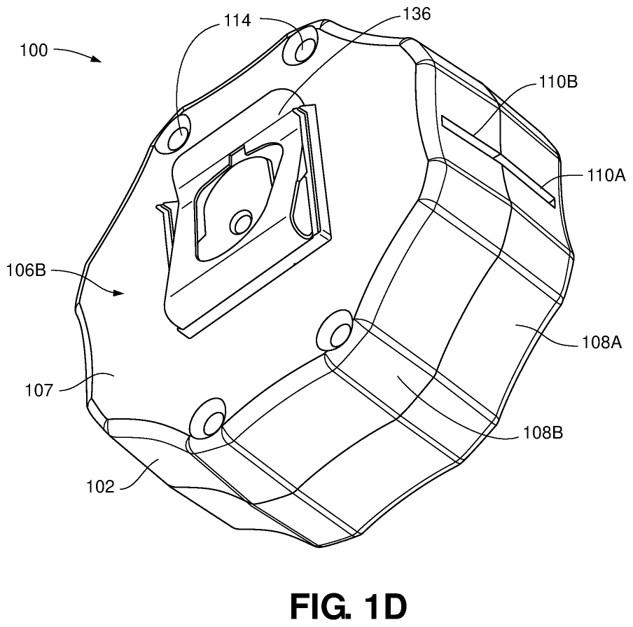

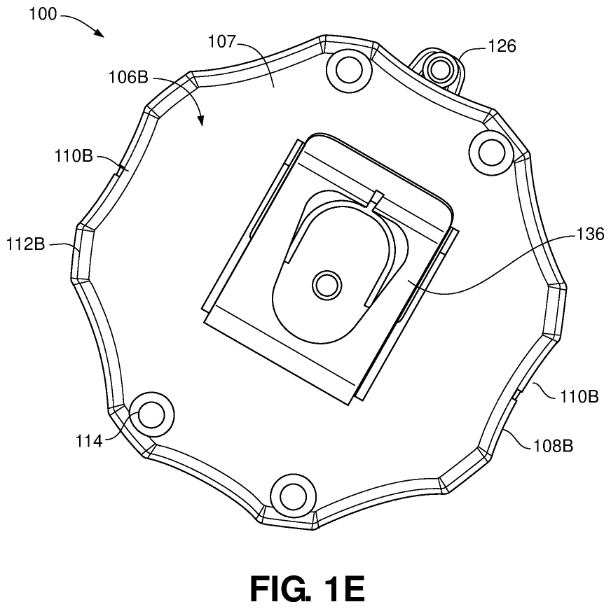

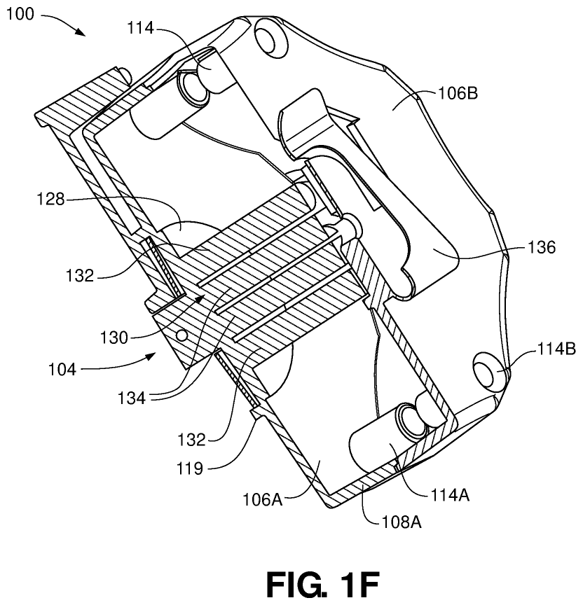

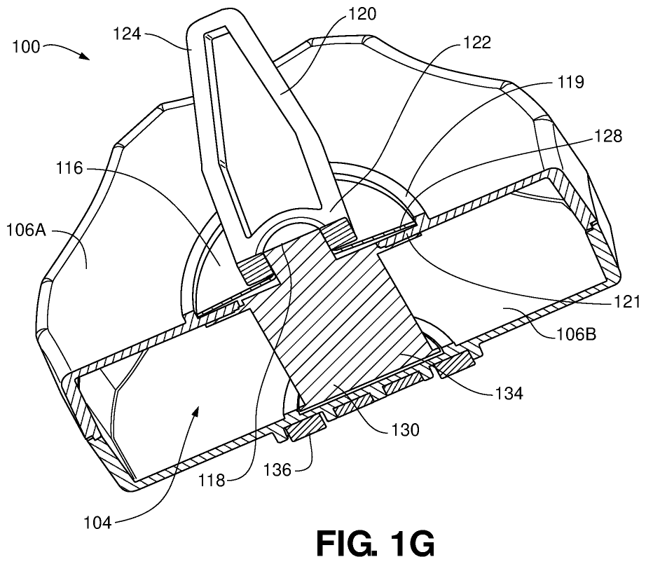

Referring to FIGS. 1A-1G, a strap container 100 configured to provide compact, persistent storage of preexisting ratchet straps is depicted according to an embodiment. Strap container 100 generally includes housing 102 and winding assembly 104.

Housing 102 is generally split into cover segments 106A and 106B, each having respective perimeter walls 108A, 108B, slits 110A, 110B, and protuberances 112A, 112B. Cover segment 106B, treated herein as the back cover of housing 102, further includes fastener apertures 114B. Whereas cover segment 106A is treated as the front cover of the housing 102 and includes fastener apertures 114A within an interior portion of cover segment 106A, as seen in FIG. 1F. Cover segments 106A, 106B are configured to be removably coupled via fasteners (for example and without limitation, screws, pins, bolts, or clips) inserted into a plurality of fastener apertures 114B that extended to corresponding fastener apertures 114A, such that perimeter wall 108A, slits 110A, and protuberances 112A align with perimeter wall 108B, slits 110B, and protuberances 112B respectively. When coupled, slits 110A, 110B effectively form a single elongated slot for a strap to pass through when in use. In general, when front cover segment 106A and back cover segment 106B are coupled, their perimeter walls are in substantial alignment and form the sidewall of housing 102, such that they define an enclosed, interior compartment in which a strap can be stored.

Winding assembly 104 is configured to rotate independently from and pass through an aperture in a base wall 109 of cover segment 106A. On an exterior side of cover segment 106A, as seen in FIG. 1C, winding assembly 104 includes an exterior base 116, hinge 118, and handle 120. Handle 120 includes a proximal portion 122 and a distal portion 124, the distal portion having a protrusion 126 extending therefrom (see FIG. 1A).

On an interior side of cover segment 106A, as seen in FIGS. 1F-1G, winding assembly 104 includes an interior facing side of base 116 and strap coupling mechanism 130. In the embodiment, exterior base 116 is a thin, circular disc positioned in the center of perimeter wall 108A of cover segment 106A, such as concentrically centered therein. In some embodiments, housing 102 (or front cover segment 106A of housing 102) includes ridge 119 protruding from its base wall 109, with ridge 119 facing either externally or internally into the compartment defined by the housing. For example, exterior base 116 of the winding assembly can be disposed within a slightly elevated, exterior ridge 119, such as a circular ridge, as compared to the base wall of front cover segment 106A or housing 102. In some embodiments, the exterior base 116 may be rotatable within exterior ridge 119, which in part prevents the winding assembly 104 from falling out of alignment while rotating. In embodiments, ridge 119 may have a slightly larger diameter than the exterior base 116, where ridge 119 is circular and base 116 is shaped as a thin disk, and a circular ridge 119 may encircle the circumference of disk-shaped base 116.

An interior facing side of base 116 includes, for example, interior wall 128. In some embodiments, interior wall 128 may slidably engage an inner portion of an exterior surface of base wall 109 as a user rotates the winding assembly. For example, an inner portion 121 of the exterior surface of base wall 109 may extend within an interior of ridge 119, such that interior wall 128 of a base 116 rotates smoothly about inner portion 121 of the exterior surface of base wall 109, as shown in FIG. 1G. In such an embodiment, base 116 is disposed exterior to housing 102.

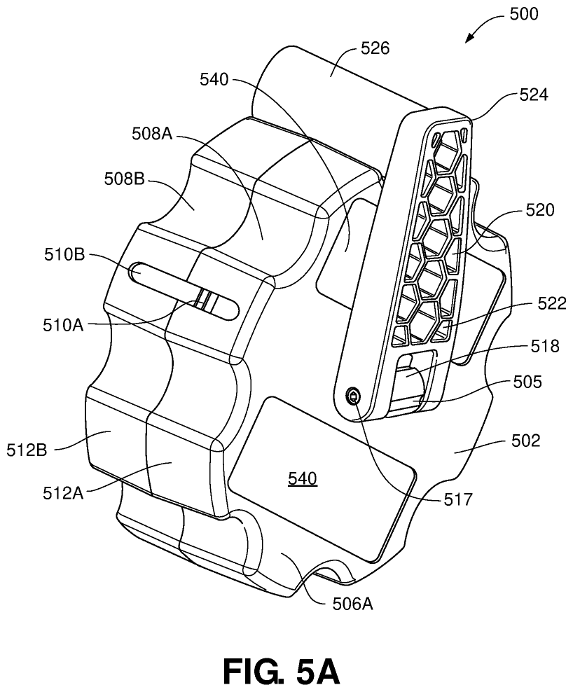

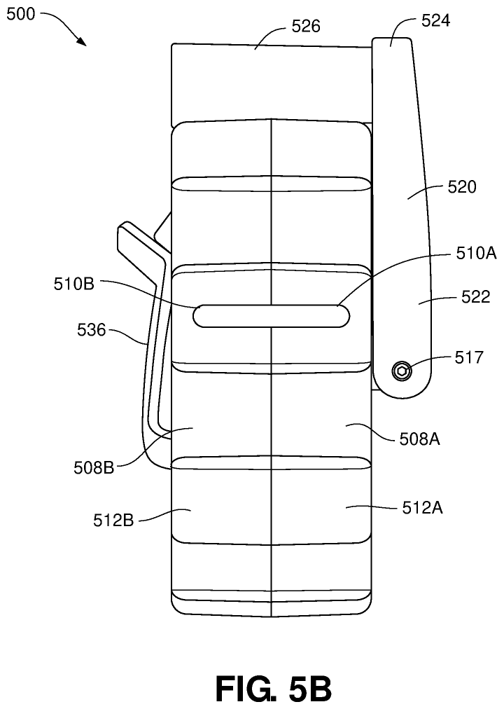

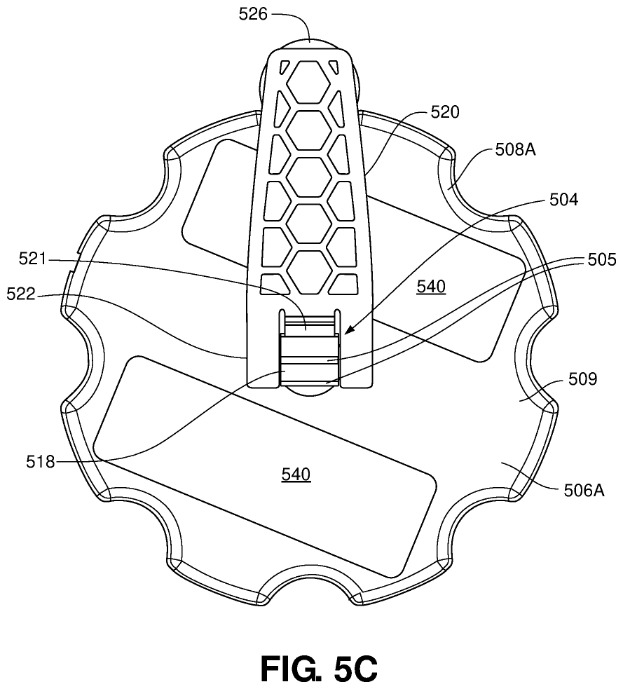

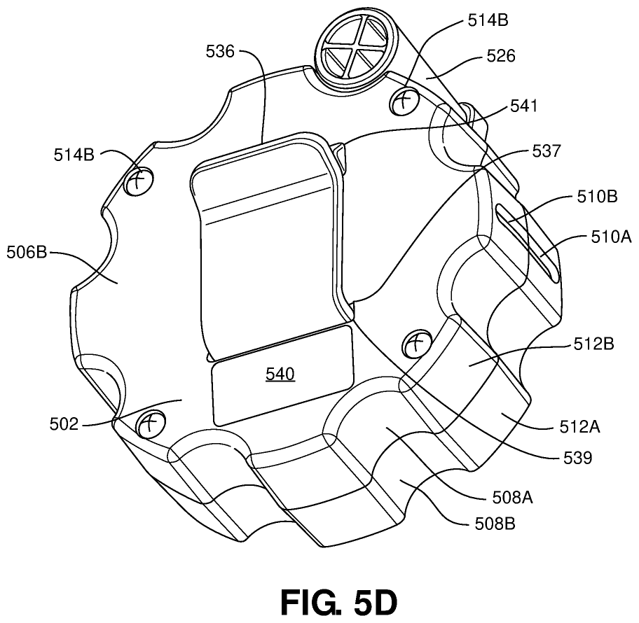

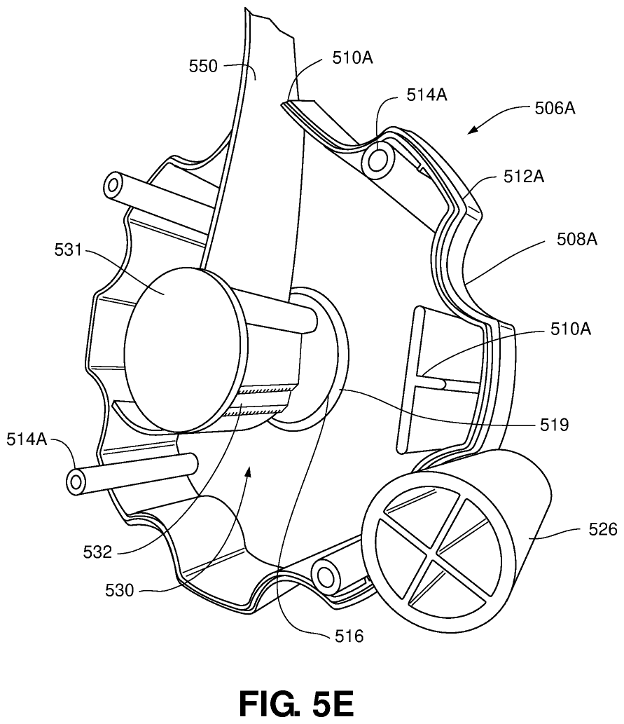

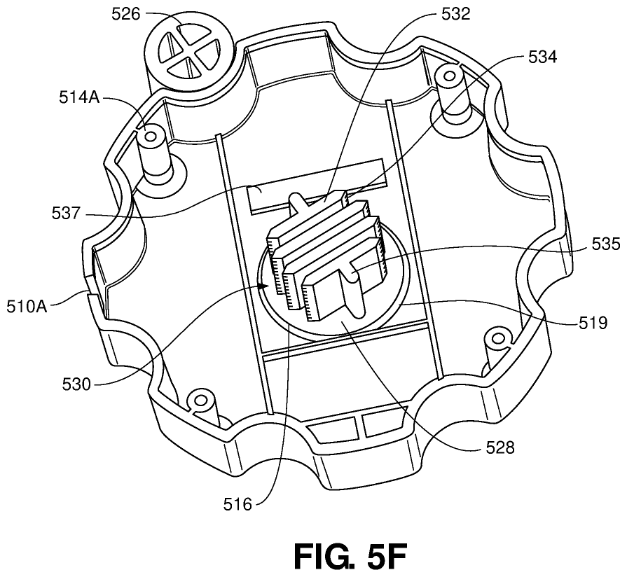

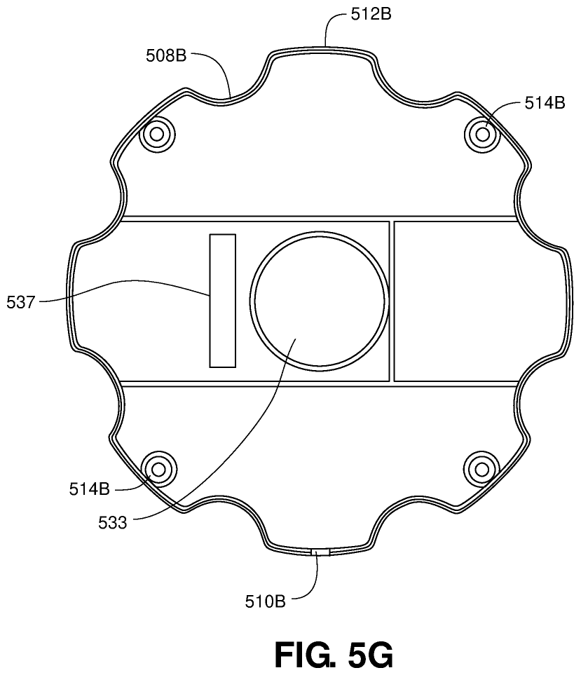

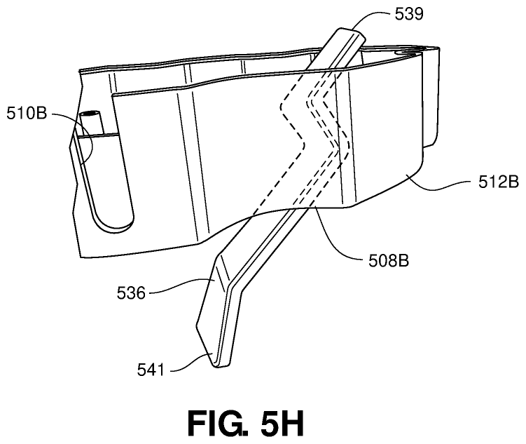

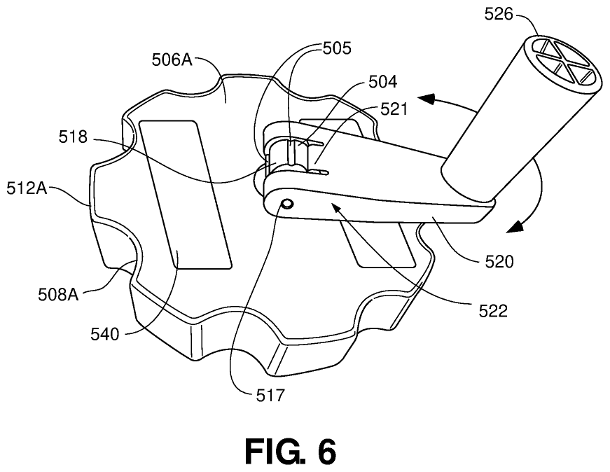

In other embodiments, the base of the winding assembly of the disclosed strap container is disposed on the interior of the base wall of the housing or front cover segment. For example, as shown at FIG. 5F, a thin, disk-shaped base 516 is disposed on the interior of the housing of an alternative embodiment of the disclosed strap container, and circular ridge 519 encircles base 516 and is also disposed within the housing. In this example, while not shown in FIG. 5F, base 516 has a diameter or width that is larger than the diameter or width of the aperture in the base wall of the housing through which hinge 518 passes (see, e.g., FIG. 5C), and a proximal portion 522 of handle 520 has a width greater than the aperture in the base wall. As shown, for example, at FIGS. 5C and 6, hinge passes through an aperture in front cover segment 506A. In this way, the handle of the winding assembly further serves as a means to secure the winding assembly to the housing. Thus, in general, the winding assembly of this disclosure may include a handle, hinge, base, and strap coupling mechanism, all of which are directly or indirectly connected (or unitary in nature), such that all components of the winding assembly can be rotated together when a strap is being wound up and retracted within the housing, or when the strap is being unwound while the handle is in the neutral or deployed position.

Strap coupling mechanism 130 of the winding assembly of the disclosed strap container extends inwardly into the compartment defined by the housing, extending from either or both of interior wall 128 of base 116 or from hinge 118, such that strap coupling mechanism 130 is configured to removably receive tie down strap 150. For example, as shown in FIG. 5F, described in more detail below, strap coupling mechanism 530 extends inwardly from an interior wall 528 of base 516. In some embodiments, strap coupling mechanism 130 includes support prongs 132 or securing planes 134, or both support prongs 132 and securing planes 134. Support prongs 132 and securing planes 134 extend from interior wall 128 and are sized such that strap coupling mechanism 130 can rotate within housing 102 with at most a clearance fit with cover segment 106B.

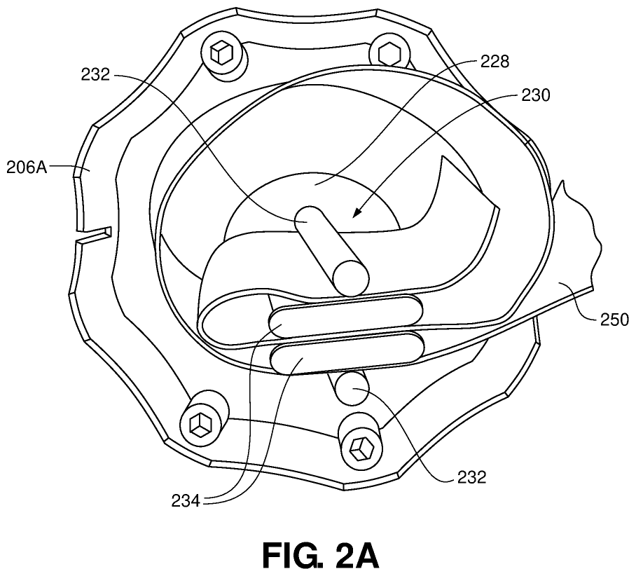

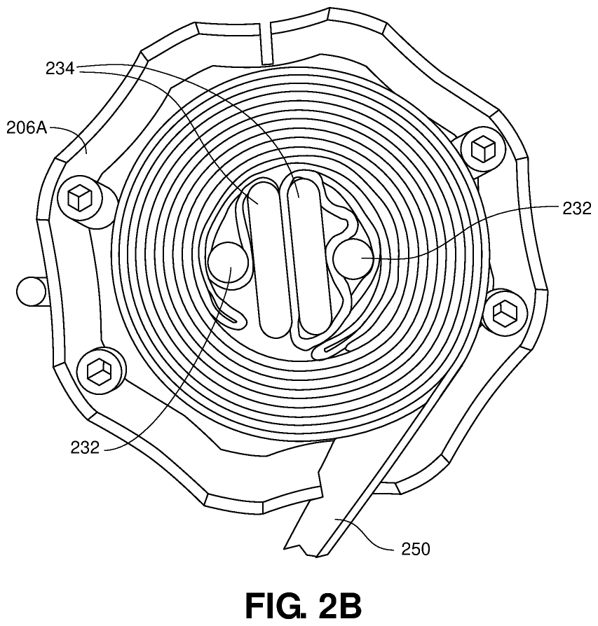

Although the depicted embodiment of strap coupling mechanism 130 includes support prongs 132 flanking securing planes 134 (or as in FIG. 2, coupling mechanism 230 including support prongs 232 flanking securing planes 234), support prongs 132 and securing planes 134 could be arranged in any manner that enables secure retention of a strap as contemplated herein. For example, in an embodiment, two support prongs 132 could instead be flanked by securing planes 132. Further, winding assembly 104 could instead include four support prongs 132 or four securing planes 134, rather than a combination of both elements, to retain a strap. In some embodiments, securing planes 134, 234 can be arranged such that they are aligned in parallel with each other within the housing of the strap container. In some embodiments, two or more support elements can be used to retain a strap. The support elements can be knurled, or have a plurality of teeth, notches, or ridges, to improve retention of the support strap, as shown for example in FIG. 5F. Thus, it should be understood that the intention is not to limit the claimed inventions to the particular embodiments described and shown by way of example in the drawings. On the contrary, the intention is to cover all modifications, equivalents, and alternatives falling within the spirit and scope of the subject matter as defined by the claims.

In some embodiments, slits 110A, 110B are sized to closely outline the perimeter of a strap stored within strap container 100 and to prevent the strap from folding during storage.

In some embodiments, housing 102 further includes optional fastener 136. Fastener 136 permits strap container 100 to be removably coupled to a portion of a ratchet strap that is exterior to strap container 100 and being used to secure cargo, for example, or to other surfaces. Fastener 136 can be one or more of a clip, a hook and loop fastener, an adhesive, a magnet, and other known fastening means. Moreover, fastener 136 may be removably or fixedly coupled to housing 102. In some examples, as shown in FIGS. 1D and 1E, fastener 136, such as a clip, can be removably or fixedly coupled to a base wall 107 of back cover segment 106B of housing 102. In examples where a clip is removeable, it is thus easily replaceable with new clips as needed.

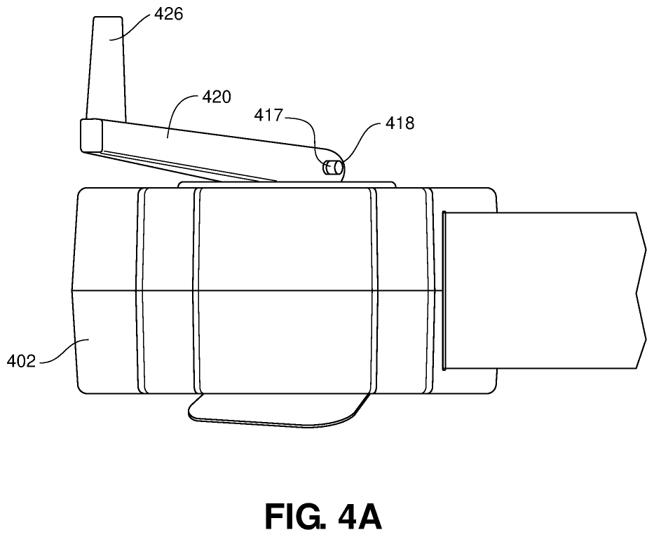

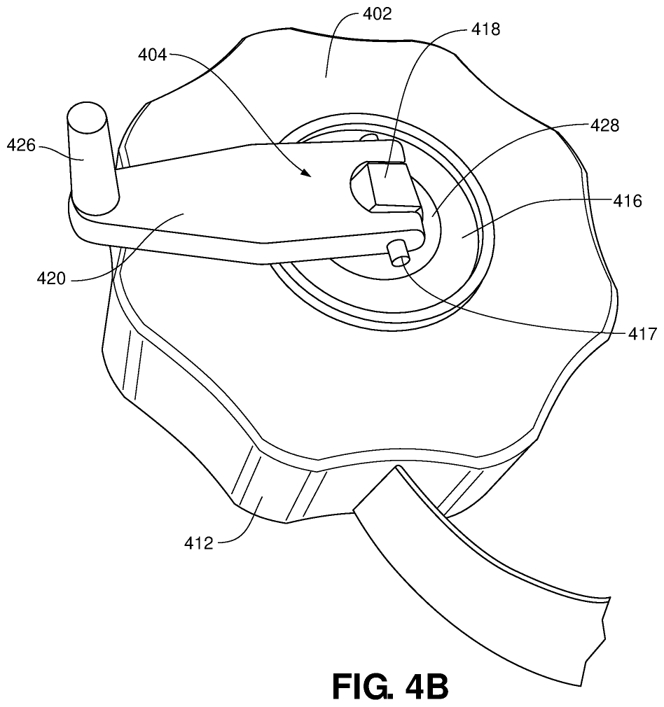

Handle 120 is operable to switch between a stowed position, as depicted in FIGS. 1A-1G, and a deployed position, as depicted in FIGS. 4A and 4B. Switching between these positions is enabled by rotatable hinge 118, which allows handle 120 to change orientation of protrusion 126 relative to housing 102.

When in a deployed position, protrusion 126 can face away from housing 102 such that a user can rotate winding assembly 104 by exertion of force on handle 120 without handle 120 being inhibited by protuberances 112A, 112B, allowing for deployment or retraction of a strap stored in strap container 100. When in a stowed position, protrusion 126 rests alongside or against perimeter walls 108A, 108B between protuberances 112A, 112B. In the stowed position, rotation of handle 120 relative to housing 102 is inhibited by protuberances 112A, 112B, which prevents a strap stored in strap container 100 from being deployed or retracted. Further, the strap is wound about itself within strap container 100 and locked in when the handle 120 is in stowed position such that the loose end of the strap, when, for example, in use to secure cargo or recreational vehicles, cannot come loose of storage container unless desired. This effectively enables handle 120 and housing 102 to act as a locking mechanism that can be quickly and efficiently engaged or disengaged while preventing unintentional unraveling of a stored strap, for example when a truck is traveling fast down a highway.

When the handle is in a stowed position, the locking mechanism can be further enhanced by offsetting the handle. Such an offset enables the strap to be tightened when the handle is in a stowed position. In some embodiments, such as that depicted in FIG. 4B, spring washer 428 is used in conjunction with this offset. In such embodiments, the storage container has a concentric design where a pin 417 of hinge 418 extends through handle 420 to fasten handle 420 to housing 402. Spring washer 428 can apply pressure such that the concentric design enables the handle to snap into the closed position. This design can require a higher threshold force to switch from the stowed position to the deployed position, reducing the risk of unintentional deployment.

With continued reference to FIGS. 1A-1G, the stowing system for handle 120 further enables strap container to have a minimal profile only marginally larger than that of a wound strap. The minimal profile of strap container 100 allows a user to be transportable and easily move strap container 100 between destinations, without having to remove a stored strap therefrom. The design of strap container 100 is particularly advantageous for the additional reason that a plurality of protuberances 112A, 112B on the sidewall of housing 102 provide a graspable surface that can easily be held and manipulated when turning handle 120 to deploy or retract a strap. In some embodiments, strap container 100 can be handheld when sized for most standard ratchet strap dimensions.

Accordingly, strap container 100 represents an improvement over conventional solutions that require loose pins or pieces that can become separated from the container in use during rugged and industrial projects, or straps specifically manufactured for use with other types of containers, or straps that are permanently coupled to containers, or those that require re-inserting the strap into a ratchet mechanism before or after storage, and, those that otherwise incorporate bulky or otherwise unwieldy winding solutions.

Further, in some embodiments, the strap container includes no openings other than the slot necessary to deploy the strap, which limits exposure to dirt and debris that can degrade the strap while stored, and the interior winding assembly. In some embodiments, the strap container includes only one slot. The enclosure of a strap within the strap container expands the useable life of the strap. It also reduces the frequency a user would have to install the strap into the strap container. The minimal openings of the strap container additionally provide storage benefits by preventing tangling and enabling quick deployment.

Referring to FIG. 2A, a front cover segment portion of a strap container is shown with a strap secured within a strap coupling mechanism according to the one or more embodiments described herein. The strap container is substantially similar to strap container 100 and similar reference numerals are used to refer to similar elements. For example, cover segment 206A is generally the same as cover segment 106A.

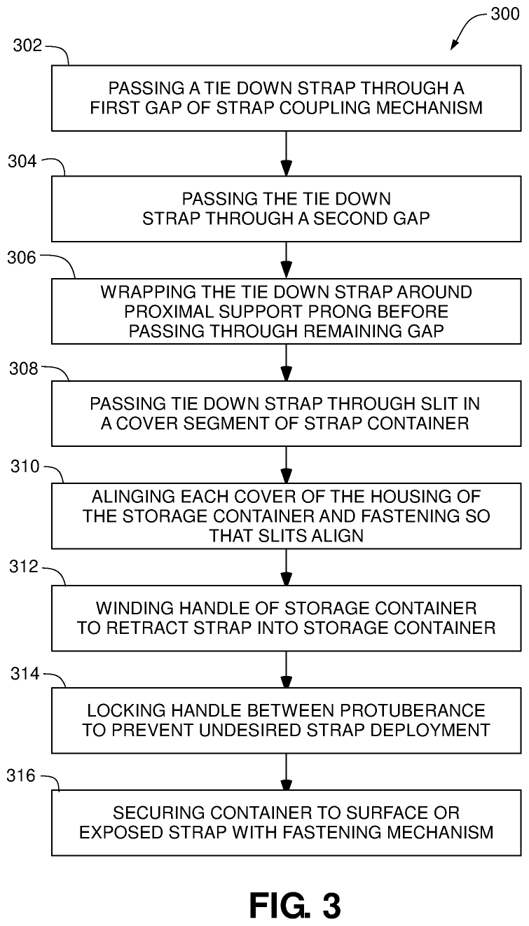

An example strap coupling mechanism 230 extends from interior wall 228 of the base of the winding assembly and includes support prongs 232 and securing planes 234. Strap 250 can be secured to the strap container by weaving strap 250 through the gaps or spaces between support prongs 232 and securing planes 234 as depicted (and later described with reference to FIG. 3). FIG. 2B shows cover segment 206A storing a greater portion of strap 250. A pulling force applied to the portion of the strap external to the strap container would tighten the strap wound around strap coupling mechanism, effectively preventing the strap from detaching during use. The device can be further secured by, for example, clipping the container to the strap using fastener 136, such as during transport.

Referring now to FIG. 3, a flowchart of a method 300 for securing a tie down strap to a storage container of the present disclosure is depicted, according to an embodiment.

At step 302, the tie down strap is passed through a first gap created by strap coupling mechanism 130. For example, for storage container 100, the first gap could be the gap between the support prong 132 and the securing plane 134.

At step 304, the tie down strap is passed through a second gap.

At step 306, the tie down strap is wrapped around the proximal support prong 132 before being passed through the remaining gap as shown in FIG. 2. In some embodiments, with two or more support elements the strap can simply be wrapped after passing through one or more created gaps. In such embodiments, the support elements can be knurled to better retain the strap.

At step 308, the tie down strap is passed through a slit in a cover segment of storage container 100.

At step 310, each cover of the housing of storage container 100 is appropriately aligned and fastened, aligning the slot around the perimeter of the strap.

At step 312, the handle can be wound when in a deployed position to retract the strap into the housing of storage container.

At step 314, the handle can be placed into a stowed position by pivoting the handle such that the protrusion is placed between protuberances of the housing.

At step 316, the handle can be secured to a surface or a portion of the strap that is not stored within the strap container.

It should be understood that the individual operations used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Notably, while the embodiments depicted in FIGS. 1A-1G and 2A-B include the housing of the strap container having two cover segments, such a structure is not required. In alternative embodiments, the housing could be a unitary structure. In such embodiments, the back side of the housing can be opened, such as pivotally via hinges. The back side can therefore function as a lid or door with which one could secure a strap within the strap coupling mechanism of the strap container. Similarly, embodiments that include two separate cover segments can incorporate a hinge, clips, or other fastening means to connect the cover segments.

Referring now to FIGS. 4A-4B, a perspective view of a strap container is shown with a handle in a deployed position according to the one or more embodiments described herein. The strap container is substantially similar to strap container 100 and similar reference numerals are used to refer to similar elements.

Winding assembly 404 is configured to rotate independently from and pass through an aperture in housing 402. In some embodiments, handle 420 is pivotably coupled to base 416 via hinge 418. Protrusion 426 can accordingly be used as a grip when in a deployed position as depicted or as a locking means when between protuberances 412 of housing 402.

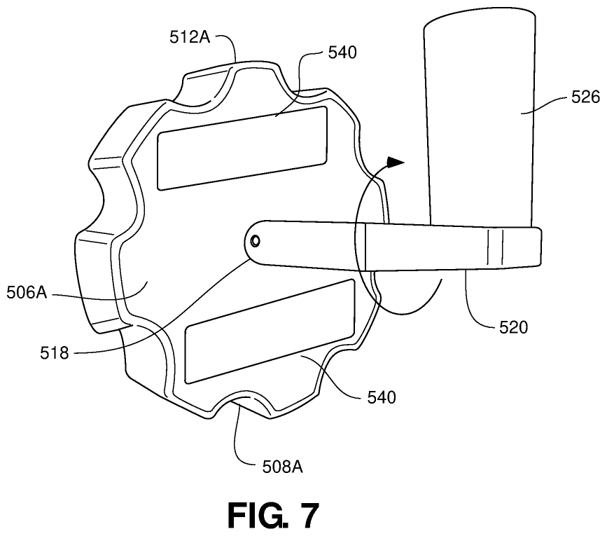

Referring to FIGS. 5A-5H and FIG. 6, an alternative strap container 500 can be configured to provide compact, persistent storage of preexisting ratchet straps depicted according to an embodiment. Strap container 500 generally includes housing 502, and winding assembly 504, including a rotatable hinge 518 of the winding assembly. In some example embodiments, one or more detents 505 (such as grooves) may be present in hinge 518. For example, three detents on hinge 518 may be formed in handle 520 to facilitate retention of handle 520 in three respective positions. In such embodiments, the example three positions can include a stowed or locked position (shown in FIGS. 5A-H), a deployed position (shown in FIG. 6), and a neutral position (shown FIG. 7), described in greater detail below. Further, in such examples, a proximal portion 522 of handle 520 may include a member that engages a detent to retain the handle in a particular position. For example, handle 520 may include a protrusion 521 that slidably engages one or more grooves formed on an exterior surface of hinge 518. Moreover, in some examples a portion of the exterior surface of hinge 518 is curved, such as forming a half-circle in its lateral cross-section. In such examples, protrusion 521 of handle 520 slidably engages hinge 518 when a user pivots handle 520, between positions marked by detents, or otherwise. In such embodiments, for example, a first detent or groove in the hinge retains the handle in a deployed position to facilitate winding to retract a strap, a second detent or groove retains the handle in a neutral position that enables applying a pulling force to the strap to deploy the strap which rotates the winding assembly, and a third detent or groove retains the handle in a stowed position such that a protrusion of the handle can be locked between two protuberances of the two or more protuberances (e.g., such as ridges) formed in the sidewall around the circumference of the housing, to prevent retraction or deployment of the strap.

Housing 502 is generally split into cover segments 506A and 506B (e.g., front cover segment 506A and back cover segment 506B), each having respective perimeter walls 508A, 508B, including a plurality of indentations configured to receive protrusion 526 of handle 520 in the stowed position, wherein the handle 520 is prevented from moving or rotating while in the stowed position. Housing 502 can further include slits 510A, 510B in perimeter walls 508A and 508B, respectively, as well as protuberances 512A, 512B in perimeter walls 508A, 508B, respectively. In some embodiments, slits 510A and 510B are positioned in protuberances 512A and 512B, respectively. Cover segment 506B, treated herein as the back cover of housing 502 further includes fastener apertures 514B. Whereas cover segment 506A is treated as the front cover of the housing 502 and includes fastener apertures 514A within an interior portion of cover segment 506A, as seen in FIG. 5E-5G. Cover segments 506A, 506B are configured to be removably coupled via fasteners inserted into a plurality of fastener apertures 514B that are extended to corresponding fastener apertures 514A, such that perimeter wall 508A, slits 510A, and protuberances 512A align with perimeter wall 508B, slits 510B, and protuberances 512B respectively. When coupled, slits 510A and 510B effectively form a single elongated slot for a strap to pass through when in use.

Winding assembly 504 is configured to rotate independently from and pass through an aperture in a base wall 509 of cover segment 506A. On an exterior side of cover segment 506A, as seen in FIG. 5C, winding assembly 504 includes a rotatable hinge 518 and handle 520. Handle 520 includes a proximal portion 522 and a distal portion 524, the distal portion 524 having a protrusion 526 extending therefrom (see FIG. 5A).

On an interior side of cover segment 506A, as seen in FIGS. 5E-5G can include winding assembly 504, coupled to an interior base components 516 (e.g., similarly functional to the exterior base 116 reflected in FIGS. 1A-1C and 1G), which can include an interior facing side and strap coupling mechanism 530. In the embodiment, winding assembly 504 can include a strap coupling mechanism 530 positioned within the housing and partially through the center of perimeter wall 508A of cover segment 506A, via externally exposed portion of winding assembly 504. In embodiments, strap coupling mechanism can be positioned within the housing such that it is concentrically centered therein. Strap coupling mechanism 530 extends from the interior facing side of rotatable hinge 518 and is configured to removably receive tie down strap 550. In some embodiments, strap coupling mechanism 530 includes support prongs 532 and securing planes 534. Support prongs 532 and securing planes 534 extend from interior base and are sized such that strap coupling mechanism 530 can rotate within housing 502 with at most a clearance fit with cover segment 506B. In embodiments, each respective edge of the securing planes 534 can be constructed to have ridges, teeth, or otherwise partially serrated edges, as clearly depicted in FIGS. 5E and 5F. For example, the serrated edges, teeth or otherwise serrated edges enable for increased grip or securement of the strap 550 within the winding mechanism whether during use or in a stationary position (e.g., in the deployed position, stowed position, or the neutral position). In some embodiments, strap coupling mechanism 530 can include a cap 531 coupled to the distal end, opposite the rotatable hinge 518. Cap 531 configured to be received within an open space 533 of the cover segment 506A, such that the coupling mechanism 530 can be rotatable within open space 533 when the handle 520 is rotated, via rotatable hinge 518 (e.g., clockwise or counterclockwise). In embodiments, the open space 533 can be configured to be elongated and, at least be partially circular or oval shaped, in which the insertable fastener 536 may be received and configured to mount or otherwise secure the strap container 500 with another object.

Although the depicted embodiment of strap coupling mechanism 530 includes support prongs 532 and securing planes 534, it is important to note that support prongs 532 and securing planes 534 can be arranged in any manner that enables secure retention and wrapping of a strap as contemplated herein. For example, in an embodiment, a plurality of support prongs 532 included to provide a plurality of securing planes 534. Further, winding assembly 504 could instead include four support prongs 532 and three securing planes 534. In some embodiments, two or more support elements 535 (see FIG. 6) can be used to retain a strap. The support elements 535 can be knurled to improve retention of the support strap. Thus, it should be understood that the intention is not to limit the claimed inventions to the particular embodiments described and shown by way of example in the drawings. On the contrary, the intention is to cover all modifications, equivalents, and alternatives falling within the spirit and scope of the subject matter as defined by the claims.

In some embodiments, slits 510A and 510B are sized to closely outline the perimeter of a strap stored within strap container 500 and to prevent the strap from folding during storage.

In some embodiments, housing 502 further includes optional fastener 536. Fastener 536 permits storage container 500 to be removably coupled to a portion of a ratchet strap that is exterior to storage container 500 and being used to secure cargo, for example, or to other surfaces. Fastener 536 can be one or more of a clip, a hook and loop fastener, an adhesive, a magnet, and other known fastening means. In embodiments, fastener 536 can be of a single, removable piece, insertable into fastening insert 537 of cover segment 506B. Referring to FIG. 5H, in some examples, fastener 536 can be generally an elongated S shape, such that a portion of the insertable end 539 is inserted into fastening insert 537, which can apply opposing pressure such that the fastener 536 is help in place. In embodiments, fastener 536 can further secure to cargo or other surfaces and be coupled to or otherwise receivable or insertable at the opposing end 541.

In some embodiments, such as the alternative strap container disclosed, handle 520 is operable to switch between a stowed position, as depicted in FIGS. 5A-5C, a deployed position, as depicted in FIG. 6, or neutral position, as depicted in FIG. 7. Switching between these positions is enabled by hinge 518, via detents 505, which allows handle 520 to change orientation of protrusion 526 relative to housing 502 and remain therein.

When in a deployed position, protrusion 526 can face away from housing 502 such that a user can rotate winding mechanism 504 by exertion of force on handle 520 without handle 520 being inhibited by protuberances 512A, 512B, allowing for deployment or retraction of a strap stored in strap container 500. When in a stowed position, handle 520 can be folded into indentations between protuberances 512A, 512B and sprung into and held into position via detent 505. Thus. protrusion 526 can rest alongside or against perimeter walls 508A, 508B between protuberances 512A, 512B. In the stowed position, rotation of handle 520 relative to housing 502 is inhibited by protuberances 512A, 512B, which prevents a strap stored in strap container 500 from being deployed or retracted. Further, the strap is wound about itself within strap container 500 and locked in when the handle 520 is in stowed position such that the loose end of the strap, when, for example, in use to secure cargo or recreational vehicles, cannot come loose of storage container unless desired. This effectively enables handle 520 and housing 502 to act as a locking mechanism that can be quickly and efficiently engaged or disengaged while preventing unintentional unraveling of a stored strap, for example when a truck is traveling fast down a highway.

In embodiments, the storage container can include a concentric design where a pin 517 of hinge 518 can extend through handle 520 to fasten handle 520 to housing 502 and hinge 518. In embodiments, detents 505 configured to maintain the handle 520 and winding mechanism 504 in the selected position (e.g., stowed, deployed, or neutral position) until a minimum external force is exerted by a user to fold or otherwise manipulate between positions and, thus, between each detent 505 associated with each position of the handle 520 and winding mechanism 504. In embodiments, the detents 505 can be configured to provide pressure or restriction such that the handle can snap or spring into the closed/stowed, deployed, or neutral position. Detent 505, associated with the stowed position, can be configured to require a higher threshold force to switch from the stowed position to the deployed or neutral position (e.g., increasing the depth or securabulity of the detent 505 positioned for the deployed position, requiring a greater force to move). Thus, the risk of unintentional deployment is reduced.

With continued reference to FIGS. 5A-5H, the stowing functionality for handle 520 further enables strap container to have a minimal profile only marginally larger than that of a wound strap. The minimal profile of strap container 500 allows a user to be transportable and easily move strap container 500 between destinations, without having to remove a stored strap therefrom. The design of strap container 500 is particularly advantageous for the additional reason that a plurality of protuberances 512A, 512B on the sidewall of housing 502 provide a graspable surface that can easily be held and manipulated when turning handle 520 to deploy or retract a strap. In some embodiments, strap container 500 can be handheld when sized for most standard ratchet strap dimensions.

Accordingly, strap container 500 represents an alternative improvement over conventional solutions that require loose pins or pieces that can become separated from the container in use during rugged and industrial projects, or straps specifically manufactured for use with other types of containers, or straps that are permanently coupled to containers, or those that require re-inserting the strap into a ratchet mechanism before or after storage, and, those that otherwise incorporate bulky or otherwise unwieldy winding solutions.

Further, in some embodiments, the strap container includes no openings other than the slot necessary to deploy the strap, which limits exposure to dirt and debris that can degrade the strap while stored, and the interior winding assembly. In some embodiments, the strap container includes only one slot. The enclosure of a strap within the strap container expands the useable life of the strap. It also reduces the frequency a user would have to install the strap into the strap container. The minimal openings of the strap container additionally provide storage benefits by preventing tangling and enabling quick deployment.

In embodiments, particularly referring to FIGS. 5A, 5C, 5D, and 7, strap container 500 can be configured to include at least one section 540 integrated or coupled to the exterior of cover segments 506A or 506B, perimeter walls 508A or 508B, or protuberances 512A or 512B. The at least one section 540 can be configured to include an area for branding, advertisement, acknowledgement, or otherwise exposure of information. In embodiments, the at least one section 540 can be an indentation among cover segments 506A or 506B, perimeter walls 508A or 508B, or protuberances 512A or 512B, a smooth surface, or otherwise configured to receive the branding, advertisement, acknowledgement, or otherwise exposure of information (e.g., via a sticker, embossing, etching, laser engraving, drawn, etc.). In some embodiments, the at least one section 540 can be configured to receive removable plates with the branding, advertisement, acknowledgment, or other information. In embodiments, the removable plates can be attached and detached within the at least one section 540.

Refereeing, in particular, to FIGS. 5E and 5F, front cover segment portion 506A of a strap container is shown with a strap 550 secured within a strap coupling mechanism 530 according to the one or more embodiments described herein. Strap coupling mechanism 530 extends from the internal base of the winding assembly and is rotatably coupled to the hinge 518. Strap coupling mechanism 530 may include support prongs 532 and securing planes 534. Strap 550 can be secured to the strap container by weaving strap 550 through the gaps or spaces of the securing planes 534 between support prongs 532 as depicted. In embodiments, strap 550 can be wrapped around strap coupling mechanism 530 when the handle 520 is rotated (e.g., clockwise or counterclockwise) while in the deployed position. A pulling force applied to the portion of the strap external to the strap container would tighten the strap wound around strap coupling mechanism, effectively preventing the strap from detaching during use. The device can be further secured by, for example, clipping the container to the strap using fastener 536, such as during transport. In embodiments, strap 550 can be unwrapped from strap coupling mechanism 530 when the handle 520 is rotated in an opposite direction while in the deployed position. In embodiments, the strap is configured to be received or exited through or otherwise between slits 510A. 510B. A releasing force applied to the portion of the strap external to the strap container would loosen the strap 550 wound around strap coupling mechanism 530, effectively allowing the strap 550 to detach and exit through slits 510A, 510B.

In some embodiments, the interior side of cover segment 506A, can include an interior facing base 516 coupled with strap coupling mechanism 530. In the embodiment, interior facing base 516 can be a thin, circular disc positioned in the center of perimeter wall 508A of cover segment 506A, such as concentrically centered therein. In embodiments, interior facing base 516 can be disposed within a slightly elevated internal ridge 519 of the housing, compared to the inner side wall of the front cover segment 506A (e.g., protruding internally within the housing). For example, the interior facing base 516 may be rotatable within the circumference of internal ridge 519, while preventing the winding assembly 504 from falling out of alignment within the housing 502. In embodiments, internal ridge 519 may have a larger diameter than the interior base 516. In some embodiments, internal ridge 519 has a right-triangle cross section, with the right-angle side facing inward and the top of the slope forming the ridge around the interior facing base 516. In some embodiments, an inner portion of the housing is disposed adjacent to the exterior surface of interior facing base 516, such that base 516 rotates upon the inner portion, in the center of which is the aperture through which hinge 518 passes.

In some embodiments, a method for securing a tie down strap 550 to a storage container of the present disclosure is the same or similar to that of the method of FIG. 3 and, for ease, will not be repeated.

Referring now to FIG. 6, a perspective view of alternative strap container 500 is shown with a handle 520 in a deployed position according to the one or more embodiments described herein. Winding assembly 504 is configured to rotate independently from and pass through an aperture in housing 502. In embodiments, handle 520 is pivotably coupled to strap coupling mechanism 530 via hinge 518. Protrusion 526 can accordingly be used as a grip when in the deployed position as depicted or as a locking means when positioned between protuberances 512 of housing 502 in the stowed position. As shown in FIG. 6, an exterior portion of hinge 518 may be rounded, such that it forms a half-circle in its lateral cross-section. Further, a proximal portion 522 of handle 520 may include a member that engages one or more detents formed in the hinge, to place and retain the handle in particular positions. For example, the member may be in the form of a protrusion on the handle that slidably engages the rounded hinge 518 with a force that permits the protrusion to snap into place when it reaches a detent, e.g., a groove, in the hinge. In this way, handle 520 can be switched between, for example, a deployed position in a first groove, a neutral position in a second groove where the handle is disposed perpendicular to the base wall of the housing, and in a stowed position in a third groove.

Referring now to FIG. 7, a perspective view of alternative strap container 500 is shown with a handle 520 in a neutral position according to the one or more embodiments described herein. In some embodiments of the disclosed strap container, handle 520 is pivotably coupled to strap coupling mechanism 530 via hinge 518 and manipulated to be set perpendicular to front cover segment 506A. In such embodiments, the handle can be positioned into detent 505 associated with the neutral position, such that the handle 520 can remain or held in place in the neutral position. During use in the neutral position, strap 550 can be pulled out of and freely unwound from within the alternative strap container 500, being pulled out of slits 510A, 510B. In some embodiments, a user can pull on a portion of strap 550 that is external from alternative strap container 500 and extract portions of strap 550 remaining within strap container 500 (e.g., portions of strap 550 wrapped around strap coupling mechanism 530). However, the end of strap 550 secured within the strap coupling mechanism would remain disposed within the housing. Thus, the neutral position can allow a user to more quickly and efficiently release portions of strap 550, freeing additional amounts of strap 550 to be used to secure cargo or other articles while limiting the amount or extent handle 520 freely rotates during extraction of portions of strap 550. The neutral position of the handle thus prevents or minimizes the potential for handle 520 or protrusion 526 from coming into contact with the user or another individual. Providing an additional position, e.g., a neutral position, limits and reduces the amount of area in which the handle 520 or protrusion 526 can reach while expelling portions of strap 550 (i.e., as handle 520 and protrusion 526 spins or rotates, due to components being coupled to the rotatable strap coupling mechanism 530), thus reducing the area in which breaking of handle could occur.

In some embodiments, the strap container is approximately 5″ in diameter on its front and back and 1¾ ″ in width on its side, with a handle. The handle can be used to wind up a strap and to lock the strap inside. Once the strap is cranked into the strap container, an optional clip on the other side of the strap container can be used to fasten the strap container to the portion of the strap container to the container, or to cargo for storage during transportation. Straps that may ordinarily be tangled together, take extra time to fold up, or simply left to hang freely can be kept organized and clean with the strap container. The strap container is configured to be used with existing straps.

The strap container of the present disclosure can incorporate a manual wind unit with no internal parts used for rewind or extraction. In some embodiments, the strap container has a manual locking knurled slot inside the housing to secure the strap inside. In such embodiments, both the prong and securing plane can be knurled. There are knurled indentations or ridges around the outside of the housing to hold the handle and provide an ergonomic place to grip the strap container during use. In some embodiments, the strap container can be made of a polymer product.

In some embodiments, the storage assembly housing can comprise two cover segments configured to removably couple via snaps, by snapping together, clips, adhesives, or other temporary fastening means.

In some embodiments, a strap container of the present disclosure is a storage assembly configured to removably store a ratcheting strap. The storage assembly includes a winding assembly and a housing defining a compartment configured to store a loose end strap of the ratcheting strap. The housing can be comprised of a first cover segment and a second cover segment, each of which includes an exterior surface defining a perimeter having two or more protuberances (e.g. ridges). Each cover segment further includes an outer wall extending around the perimeter from an interior side of the surface, the outer wall having one or more slits. The first cover segment and second cover segment can be removably coupled such that the one or more slits align to form one or more slots that the ratcheting strap can pass through. The winding assembly has a base extending through an aperture in the surface of the first cover segment such that the winding assembly is configured to rotate independently from the housing. The winding assembly includes, on the exterior of the housing, a handle including a protrusion, the handle pivotally or fixedly coupled to the base and operable to switch between a deployed position, wherein the protrusion can be used to rotate the winding assembly, and a stowed position, wherein the protrusion is configured to rest between the two or more protuberances of the outer wall such that rotation of the winding assembly is prevented. The winding assembly further includes, on the interior of the housing, a strap coupling mechanism extending inwardly from the base of the winding assembly configured to removably receive the ratcheting strap.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A strap container configured to removably store a strap, the strap container comprising:
a housing defining a compartment configured to store at least an end of the strap, the housing having a sidewall with two or more outward protuberances and one or more slots configured to allow the strap to pass through;
a winding assembly rotatably coupled to and extending through an aperture in a base wall of the housing, said base wall being perpendicular to the sidewall, the winding assembly including:
a strap coupling mechanism configured to removably secure the end of the strap within the compartment;
a handle exterior to the compartment, the handle including a protrusion, wherein the handle is operable to switch between a deployed position and a stowed position, wherein:
in the deployed position the winding assembly can be wound to retract the strap or unwound to deploy the strap, and
in the stowed position the protrusion is configured to reside between two protuberances of the two or more protuberances of the housing, so as to prevent rotation of the winding assembly.

2. The strap container of claim 1, wherein the winding assembly further comprises a base and a hinge, the base being pivotably coupled to a proximal portion of the handle by the hinge.

3. The strap container of claim 2, wherein the hinge comprises at least one detent, and the proximal portion of the handle comprises a member configured to engage the at least one detent, such that when the member engages the detent, the handle is retained in one of the stowed position or deployed position.

4. The strap container of claim 1, wherein the handle is operable to switch between the deployed position, the stowed position, and a neutral position, such that in the neutral position, the handle protrudes perpendicular to the base wall of the housing.

5. The strap container of claim 4, wherein when the handle is positioned in the neutral position, the winding mechanism is freely rotatable such that the strap can be deployed by a pulling force.

6. The strap container of claim 1, wherein the winding assembly further comprises a base, the strap coupling mechanism extending from an interior wall of the base.

7. The strap container of claim 6, wherein the strap coupling mechanism comprises at least two securing planes.

8. The strap container of claim 1, wherein the housing further comprises a fastener coupled to a base wall of the housing.

9. The strap container of claim 1, wherein the housing comprises a front cover segment and a back cover segment, each cover segment having a perimeter wall, such that when the front cover segment is coupled to the back cover segment, their respective perimeter walls substantially align to form the sidewall of the housing.

10. A system comprising:
a strap; and
a strap container comprising:
a housing defining a compartment configured to store at least an end of the strap, the housing having a sidewall with two or more outward protuberances and one or more slots configured to allow the strap to pass through;
a winding assembly rotatably coupled to and extending through an aperture in a base wall of the housing, said base wall being perpendicular to the sidewall, the winding assembly including:
a strap coupling mechanism configured to removably secure at least the end of the strap within the compartment;
a handle exterior to the compartment, the handle including a protrusion, wherein the handle is operable to switch between a deployed position and a stowed position, wherein:
in the deployed position the winding assembly can be wound to retract the strap or unwound to deploy the strap, and
in the stowed position the protrusion is configured to reside between the two protuberances of the two or more protuberances of the housing, so as to prevent rotation of the winding assembly.

11. The system of claim 10, wherein the handle is operable to switch between the deployed position, the stowed position, and a neutral position, such that in the neutral position, the handle protrudes perpendicular to the base wall of the housing.

12. The system of claim 11, wherein the winding assembly further comprises a base and a hinge, the base being pivotably coupled to a proximal portion of the handle by the hinge, and wherein the hinge comprises at least three detents, and the proximal portion of the handle comprising a member configured to engage the detents, such that when the member engages one of the at least three detents, the handle is retained in one of the stowed position, the deployed position, or the neutral position.

13. The system of claim 12, wherein the detents comprise grooves formed in the hinge, and wherein the member of the handle is a protrusion configured to engage the grooves.

14. The system of claim 13, wherein a portion of the hinge is rounded in shape, and wherein the protrusion slidably engages the hinge when the handle is pivoted about the hinge.

15. The system of claim 12, wherein a minimum force applied by a user is required to transition the handle between positions.

16. The system of claim 10, wherein the base wall of the housing includes a circular ridge protruding externally or internally from the base wall, such that the circular ridge is configured to encircle a circumference of the base of the winding assembly, wherein the base is disk-shaped.

17. A method for removably storing a strap, the method comprising:
passing an end of the strap through a first gap in a strap coupling mechanism configured to removably secure at least an end of the strap within a first cover segment, the first cover segment having a first slit;
wrapping the strap around the strap coupling mechanism;
passing the strap through a second gap in the strap coupling mechanism;
passing the strap through the first slit;
fastening a second cover segment to the first cover segment to form a housing for storing at least the end of the ratcheting strap, the housing including two or more outward facing protuberances;
winding a handle of a winding assembly that is coupled to the strap coupling mechanism to retract the strap into the housing, the handle having a protrusion; and
preventing deployment or retraction of the strap from the housing by placing the protrusion of the handle between the two or more outward protuberances of the housing.

18. The method of claim 17, wherein the winding assembly further comprises a hinge rotatably hinge that passes through an aperture in the housing, the handle is pivotally coupled to the hinge, one or more detents are formed in the hinge, and a member extends from a proximal portion of the handle to engage the one or more detents.

19. The method of claim 17, wherein the one or more detents comprises at least three detents, such that when the handle engages a first detent it is in a deployed position to enable winding of the handle to retract the strap, when the handle engages a second detent it is in a neutral position to enable deployment of the strap, and when the handle engages a third detent it is configured to be in a stowed position to enable locking of the protrusion of the handle between two protuberances of the housing and prevent deployment or retraction of the strap.

20. The method of claim 19, further comprising a step of placing the handle in the neutral position and applying a pulling force to the strap to unwind and deploy the strap.
